(19) United States
(12) Patent Application Publication
(10) Pub. No.: US 2011/0037575 A1
(43) Pub. Date: Feb. 17, 2011

(54) Method and Apparatus for Providing Energy to Passive Tags in a Radio-frequency Identification System

(76) Inventors: Dieter Horst, Cadolzburg (DE); Matthias Lampe, Wolfenbuettel (DE); Dan Yu, Beijing (CN); Yong Yuan, Beijing (CN)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/865,378

(22) PCT Filed: Jan. 28, 2008
(86) PCT No.: PCT/EP09/50944

§ 371 Date: Nov. 2, 2010

(30) Foreign Application Priority Data
Jan. 31, 2008 (CN) 200810004983.0

(51) Int. Cl. G06K 7/01

(52) U.S. Cl. 340/10.51

(57) ABSTRACT

A method and an apparatus for providing energy to passive tags in a radio-frequency identification system in which a radio-frequency identification system uses the passive tags, a reader/writer sends commands and continuous waves alternately during a communication process, and the tags can obtain energy from these signals sent by the reader/writer, wherein at least one period is selected from those periods for transmitting the continuous waves, and for the continuous wave transmitting signals during this period, an enhanced transmitting power is used, or a extended transmitting time is used, or during this period continuous waves are sent additionally to the passive tags by an independent energy supplying apparatus provided separately, so that the passive tags can obtain from the continuous waves during the selected period more energy for reading and/or writing, thereby improving the reliability of the reading and/or writing operations, and increasing the rewritable range of the radio-frequency identification system.

### CROSS-REFERENCE TO RELATED APPLICATIONS

This is a U.S. national stage of International Application No. PCT/EP2009/050944, filed on 28 Jan. 2009. Priority is claimed on Chinese Application No. 200810004983.0, filed on 31 Jan. 2008. The entire content of both applications are incorporated herein by reference.

### BACKGROUND OF THE INVENTION

1. Field of the Invention

The present invention relates to a radio-frequency identification (RFID) technology and, more particularly to a method and an apparatus for providing energy to passive tags in a radio-frequency identification system using such passive tags.

2. Description of the Related Art

Typically, a radio-frequency identification system comprises a reader/writer (or interrogator) and the tags. In a radio-frequency identification system using passive tags, the energy of the passive tags is obtained from the radio frequency waves sent by the reader/writer. For example, in the radio-frequency identification system based on EPC C1G2 (EPC Radio-Frequency Identity Protocols Class-1 Generation-2 UHF RFID Protocol for Communications at 860 MHz-960 MHz Version 1.0.9) protocol, the reader/writer sends commands and continuous waves alternately during a communication process, the tags can obtain energy from the signals sent by the reader/writer.

The reading from and writing to the tags by the reader/writer are two main operations in the radio-frequency identification system, where a writing operation is typically executed by the reader/writer after a reading operation. When the reader/writer executes a writing operation, more energy will be consumed than a reading operation. Some tags which are far away from the reader/writer obtain less energy. Consequently, these tags may not have enough energy to perform the reliable writing operation after having executed a reading operation. Therefore, the range for performing a write operation of the reader/writer in the radio-frequency identification system using the passive tags is much smaller than the readable range, as shown in FIG. 1. This will limit many applications of such radio-frequency identification systems.

In order to improve the reliability of the writing operation and to extend the rewritable range, it is necessary to provide more energy to the passive tags in the radiofrequency identification system to perform the reliable writing operation.

In addition, when the reliability of the reading operation also needs to be improved and the readable range also needs to be extended in the radio-frequency identification system, it is also necessary to provide more energy to the passive tags in the radio-frequency identification system.

### SUMMARY OF THE INVENTION

It is therefore an object of the present invention to provide a method, an apparatus and a system for providing energy to passive tags in a radio-frequency identification system using the passive tags for the tags to obtain more energy, improve the reliability in executing the reading and/or writing operations, and to extend the read-only and/or the rewritable range of the radio-frequency identification system.

This and other objects and advantages are achieved in accordance with a first method for providing energy to a passive tag in a radio-frequency identification system, where a communication process of a reader/writer of the radio-frequency identification system comprises at least one period for transmitting command signals and at least one period for transmitting continuous waves, and the tag of the radio-frequency identification system obtains energy from the continuous waves. The reader/writer selects at least one period from the period(s) for transmitting the continuous waves as an enhanced period and the reader/writer then adjusts a gain for transmitting signals to send the continuous waves with an enhanced power during the enhanced period, and/or the reader/writer adjusts a time length for transmitting the continuous waves to the tag to send the continuous waves with an extended time length during the enhanced period.

In a preferred embodiment, the step for selecting the enhanced period comprises the reader/writer selecting at least one of a current or a subsequent period for transmitting the continuous waves as said enhanced period when the reader/writer detects that received signal strength for the tag is less than a preset reference value for the received signal strength.

In another preferred embodiment, the step for selecting the enhanced period comprises the reader/writer selecting at least one of a current or a subsequent period for transmitting the continuous waves as said enhanced period when a bit number to be written by the reader/writer into the tag is greater than a preset reference value for the bit number.

In still another preferred embodiment, the enhanced period is pre-selected by the reader/writer.

Specifically, the enhanced transmitting power is greater than a transmitting power for transmitting the command signals.

Preferably, the enhanced transmitting power is a maximum allowable transmitting power.

Preferably, the reader/writer further obtains relevant information for adjusting said gain through a training period.

The invention provides a reader/writer for realizing the disclosed embodiments of the method, comprising: a transmitting signal generating unit for generating transmitting signals to be sent to the tag, where the transmitting signals comprise at least one period for transmitting the command signals and at least one period for transmitting the continuous waves. A power adjusting unit is also provided for receiving the transmitting signals provided by the transmitting signal generating unit, and for performing a power adjustment to said transmitting signals according to a set gain. The reader/writer further comprises an antenna unit for transmitting out the transmitting signals from the power adjusting unit, a period selecting unit for selecting at least one period from the period(s) for transmitting continuous waves as an enhanced period, a gain controlling unit, where the gain controlling unit is used for adjusting the gain of the power adjusting unit to make the continuous waves reach an enhanced transmitting power during said enhanced period and/or a time length setting unit for controlling the time length of the transmitting signals of the transmitting signal generating unit to extend the time length of the above period for transmitting the continuous waves during the enhanced period.

In a preferred embodiment, the reader/writer further comprises a condition judging unit for detecting the received signal strength for the tag, where when the condition judging unit judges that the received signal strength is less than a preset reference value for the received signal strength, it triggers the period selecting unit to select at least one period from the period(s) for transmitting the continuous waves as the enhanced period.

In another preferred embodiment, the reader/writer further comprises a condition judging unit for detecting a bit number to be written to the tag where when the condition judging unit judges that the bit number is greater than a preset reference value for the bit number, it triggers the period selecting unit to select at least one period from the period(s) for transmitting the continuous waves as the enhanced period.

In preferred embodiments, the reader/writer also comprises a training unit for executing a training period and obtaining relevant information to determine the gain set for the power adjusting unit during the enhanced period and to provide the determined gain to the gain controlling unit.

The present invention also provides an alternative method for providing energy to a passive tag in the radio-frequency identification system, where one communication process of a reader/writer of the radio-frequency identification system comprises at least one period for transmitting command signals and at least one period for transmitting continuous waves, and the tag of the radio-frequency identification system obtains energy from the continuous wave signals, the radio-frequency identification system being provided with at least one independent energy supplying apparatus, the independent energy supplying apparatus selecting from the period(s) for transmitting the continuous waves at least one period as an enhanced period, the independent energy supplying apparatus monitoring the communication process of the reader/writer, and when it determines that it enters the enhanced period, the continuous waves are sent to the tag until the reader/writer starts to send a next command.

In preferred embodiments, the independent energy supplying apparatus is provided near the tag which is relatively far away from the reader/writer.

Preferably, the independent energy supplying apparatus is provided correspondingly according to a desired coverage range.

The present invention also provides an independent energy supplying apparatus for achieving the method in accordance with the alternative embodiment, comprising a period selecting unit for selecting at least one period from the period(s) that a reader/writer sends the continuous waves as an enhanced period, a period controlling unit for monitoring the communication process of the reader/writer, transmitting out an instruction for transmitting the continuous waves when it is determined that the reader/writer starts the enhanced period, and for transmitting out an instruction for stopping the transmitting of the continuous waves when it is determined that the reader/writer starts to send a next command, and a continuous wave transmitting unit for transmitting the continuous waves to the tag upon receiving an instruction for transmitting the continuous waves sent by the period controlling unit until receiving the instruction for stopping the transmitting of the continuous waves.

In conventional radio-frequency identification systems using the passive tags, a reader/writer sends continuous waves in gaps between transmitting the command signals to provide energy to the tags, and the same transmitting power is used both for transmitting the command signals and transmitting the continuous waves. An aspect of the disclosed embodiments of the method of the invention is to enhance the transmitting power of the continuous waves during the selected enhanced period, and as compared to the prior art methods, the contemplated embodiment of the method of the invention can make the tags obtain more energy from the continuous waves for the reading and/or writing operations, thereby improving the reliability of the reading and/or writing operations, and extending the read only range and/or rewritable range of the system. Moreover, the lower transmitting power is still used to send the signals during other periods, which can avoid excessive interference to the operation of other reader/writers. The disclosed embodiments of the method of the invention do not increase the time for transmitting the continuous waves. As a result, there is no extension of the time used for the reading and writing operations. If the enhanced transmitting power is triggered only when a preset condition is met, then a large interference to the operation of other reader/writers can be avoided while more power is provided to the tags to thereby improve the reliability of the reading and/or writing operations.

In another embodiment of the disclosed method of the invention, in which the time for transmitting the continuous waves is extended in comparison with the prior art method, the presently contemplated embodiment of the method can make the tags obtain, in a longer charging process, more energy for the writing operation, thereby improving the reliability of the reading and/or writing operations, and extending the read-only range and/or the rewritable range of the system. The contemplated embodiment of the method does not increase the transmitting power for the continuous waves, and therefore no additional interference to the operation of other reader/writers is created. If the extended transmitting time is triggered only when a preset condition is met, then the efficiency of reading and/or writing operations can be improved while more power is provided to the tags so as to improve the reliability of the reading and/or writing operations.

In the alternative embodiment of method of the present invention an additional independent energy supplying apparatus is added, which can be easily provided close to tags which are far away from the reader/writer, so as to supply additional energy to the tags with insufficient energy for the reading and/or writing operations, thereby improving the reliability of the reading and writing operations, and extending the read-only range and/or the rewritable range of the system. Here, there is no need for any further modifications to the existing radio-frequency identification systems, and therefore it can be easily applied to a variety of radio-frequency identification systems.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention will be described in detail herein below in combination with the drawings, in which:

FIG. 1 is an illustration of a schematic block diagram of read/write ranges in a radio-frequency identification system using passive tags;

FIG. 2 is an illustration of a schematic diagram of a process in which a reader/writer performs a reading operation to a tag in accordance with an embodiment of the invention;

FIG. 3 is an illustration of a schematic block diagram of the reader/writer for realizing the method in accordance with an embodiment of the present invention;

FIG. 4 is an exemplary schematic block diagram for the implementation of a power adjusting unit in accordance with an embodiment of the invention;

FIG. 5 is an exemplary block diagram of a power adjusting unit in accordance with an alternative embodiment;

FIG. 6 is an illustration of a schematic diagram of a process in which a reader/writer performs a writing operation to a tag in accordance with an alternative embodiment of the present invention;

FIG. 7 is an illustration of a schematic block diagram of the reader/writer for realizing the method described in FIG. 6;

FIG. 8 is an illustration of a schematic block diagram of a transmitting signal generating unit of the reader/writer in accordance with an alternative embodiment of the present invention;

FIG. 9 is an illustration of a schematic block diagram of an independent energy supplying apparatus in accordance with another embodiment of the present invention;

FIG. 10 is an illustration of a method in accordance with an embodiment of the invention; and

FIG. 11 is an illustration of a method in accordance with an alternative embodiment of the invention.

### DETAILED DESCRIPTION OF THE PREFERRED EMBODIMENTS

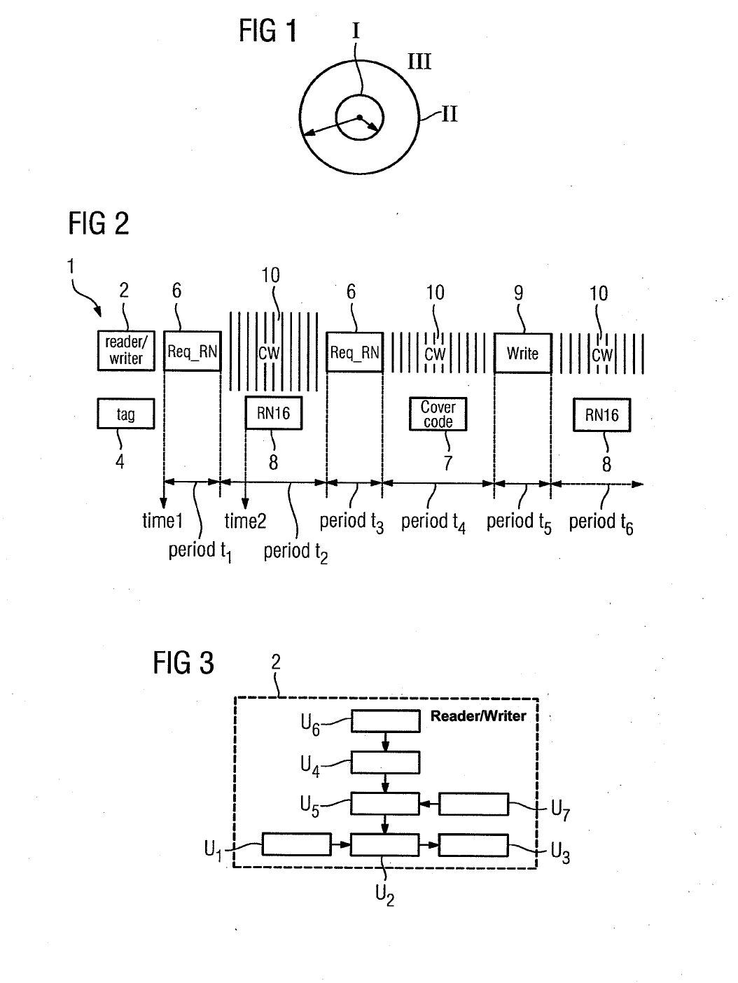

FIG. 1 is an illustration of read/write ranges, whereas the inner circle represents a rewritable range I, the outer circle presents a read-only range II and the area around the circles represents an unreadable range III.

In accordance with the present invention, by way of the embodiments described below, energy is provided to passive tags in a radio-frequency identification system 1 using such passive tags 4 (hereinafter referred to as tags), so that the tags 4 obtain more energy for performing the reading and/or writing operations reliably. From the point of view of a radio-frequency identification system 1, this means an extended coverage range.

In a first embodiment of the present invention the energy supply to the tags is increased by increasing the power strength in transmitting the continuous waves by a reader/writer.

FIG. 2 is an illustration of an exemplary process in which the reader/writer 2 performs a writing operation to a tag 4 after having performed a reading operation, where the example is based on the EPC C1G2 protocol. After the reader/writer 2 has performed the writing operation to a set of tags 4, such as at time t₁, the tags 4 having been successfully read are in an acknowledged state. At this time, the reader/writer 2 sends a Req_RN command 6 to a tag 4 in the acknowledge state. The tag 4 generates and stores a new RN16 8, which can also be called a handle and which handle is returned to the reader/writer 2 by backscattering, and it turns to an open state or a secured state, such as at time t₂. The reader/writer 2 then sends out one Req_RN command 6 with the RN16 8, and the tag returns one cover code 7 correspondingly. Then, an access command 9, such as writing, can be executed by the tag. The tag 4 returns its handle to the reader/writer 2 to indicate a successful operation, or returns an error code to indicate an unsuccessful operation.

It can be seen from the above process that, in the prior art, the reader/writer 2 sends the command signals and the continuous waves 10 (CW) during a communication process, and the tags 4 can obtain energy from the signals sent by the reader/writer 2, where the same transmitting power is used in transmitting both the command signals and the continuous waves 10. In fact, the tags 4 obtain energy mainly from the period for transmitting the continuous waves. As a result, in accordance with the present invention, from those periods, such as the periods t₂, t₄, t₆, for transmitting the continuous waves 10, the reader/writer 2 will select at least one period (e.g., the period t₂) as an enhanced period, the reader/writer 2 performs a power adjustment on the transmitted signals to send out the transmitting signals during the enhanced period (i.e., continuous signals) with an enhanced transmitting power, and the transmitting signals in the other periods, such as the periods t₁, t₃, t₄, t₅, t₆, can be sent out with a transmitting power determined by a conventional method. In the present invention, the enhanced transmitting power refers to a power greater than the power used during the period for transmitting the command signals.

Therefore, by transmitting the continuous waves 10 at the enhanced transmitting power during the enhanced period, the tags 4 can obtain more energy from the continuous waves 10. While during the other periods, a smaller transmitting power such as the transmitting power determined by conventional methods, is still used, which can avoid great interferences to the operation of the other reader/writers 2 nearby. Consequently, the tags 4 can obtain more energy for the writing operation during the enhanced period.

Specifically, a maximum allowable power can be used as the enhanced transmitting power during the period t₂. The maximum allowable transmitting power is typically limited by the radio-related regulations to avoid generating too much interference to other radio systems.

In a preferred embodiment for the adjustment, the reader/writer 2 can be triggered to select at least one period as the enhanced period when a preset condition is met, and the continuous waves 10 are sent out at the enhanced power during the period. As a result, the transmitting power of the continuous waves 10 is increased only when necessary, and the interference to the operation of the other reader/writers 2 can be reduced as much as possible. The preset condition can comprise: the received signal strength indicator (RSSI) for the tags 4 of the reader/writer 2 is less than a preset reference value for the strength of the received signal, or the bit number to be written into the tag 4 is greater than a preset reference value for the bit number. In accordance with the invention, the reader/writer 2 detects the strength of a received signal on which a writing operation needs to be performed, and then the strength of the received signal is compared with the preset reference value for the strength of the received signal, if the strength of the received signal is less than the preset reference value for the received signal strength, then the preset condition is established as being met.

In an alternative embodiment, the reader/writer 2 detects the number of bits sent to the tags 4 on which a writing operation needs to be performed currently, and then the bit number is compared with a preset reference value for the bit number, if the bit number is greater than the preset reference value for the bit number, then the preset condition is established as being met.

Preferably, the first period for transmitting the continuous waves 10 after having determined that the preset condition is met is selected as an enhanced period, and this can promptly increase the energy supply to the tags 4 with insufficient energy, thereby improving the reliability of the subsequent operation even more.

During an implementation, the above-mentioned object can be achieved by performing a gain adjustment to the power for transmitting the signals before transmitting the signals. In order to set the corresponding gain more precisely, the reference information for gain adjustment can be obtained by one or more time segments for training purposes at the starting stage of a communication process. The detailed process can refer to the method of the prior art for obtaining the relevant information, for example, the signal power and for gain setting through training periods, which will not be described in detail in the present invention.

In accordance with the contemplated embodiment, as an example, only one period t₂ is selected to enhance the transmitting power of the continuous waves 10. In an alternative embodiment, more than one period (for example, the periods t₂, t₄) can also be selected to enhance the transmitting power of the continuous waves 10. It is better to select the number of the enhanced periods according to the specific needs for energy by the tag's writing operation, so as to achieve better effects.

FIG. 3 is an illustration of a schematic block diagram of the reader/writer 2 for realizing the method described in accordance with an embodiment of the present invention.

The reader/writer apparatus comprises a transmitting signal generating unit U₁, a power adjusting unit U₂, an antenna unit U₃, a period selecting unit U₄ and a gain controlling unit U₅.

Here, the transmitting signal generating unit U₁ generates modulated transmitting signals to be sent to the tags 4, and the transmitting signals comprise at least one period for transmitting the command signals and at least one period for transmitting the continuous waves 10. The power adjusting unit U₂ receives the transmitting signals provided by the transmitting signal generating unit U₁, and performs a power adjusting to the transmitting signals in accordance with the set gain. The antenna unit U₃ sends out the transmitting signals from said power adjusting unit U₂. The above-mentioned units basically correspond to units in an existing reader/writer; for their detailed implementation reference is to be made to the prior art.

The reader/writer 2 of the present invention, however is also provided with a period selecting unit U₄, which is used for selecting at least one period from the periods for transmitting continuous waves 10 as an enhanced period.

Moreover the reader/writer 2 of the present invention, is also provided with a gain controlling unit U₅, which is used for adjusting the gain set for the power adjusting unit U₂, so as to allow the continuous waves 10 to reach the enhanced power during the enhanced period, and to obtain the transmitting power determined, for example, by the conventional method during the other periods.

The specific mode for setting the gain controlling unit U₅ for the gain can be as follows, for example, during a pre-selected enhanced period (e.g., the period t₂), a high gain is used to adjust the power of the continuous waves 10, so as to allow the transmitting power of the continuous waves 10 to reach the enhanced transmitting power, for example, to reach the maximum allowable transmitting power. During the other periods, a low gain is used to adjust the power of the transmitting signals to allow it to reach the transmitting power determined by the conventional method. This setting mode is simple to implement.

In addition, the period selecting unit U₄ can also select the enhanced period only when the preset condition is met and make the gain controlling unit U₅ adjust the set gain, so as to reduce as much as possible the interference to the operation of the other reader/writers 2 while providing enough energy to the tags 4. To achieve this purpose, the reader/writer 2 further comprises a condition judging unit U₆, which is used for detecting the received signal strength for the tags 4, and when it is determined that the received signal strength is less than a preset reference value for the received signal strength, a notice that the preset condition has been met is sent to the period selecting unit. Alternatively, the condition judging unit U₆ detects the bit number to be written into the tags 4, and when it is determined that the bit number is greater than a preset reference value for the bit number, a notice that the preset condition has been met is sent to the period selecting unit U₄.

In addition, the reader/writer 2 can also further comprise a training unit U₇, which is used for executing a training period and for obtaining relevant information, so as to determine a gain value set for the power adjusting unit U₂ during the enhanced period and provide it to the gain controlling unit.

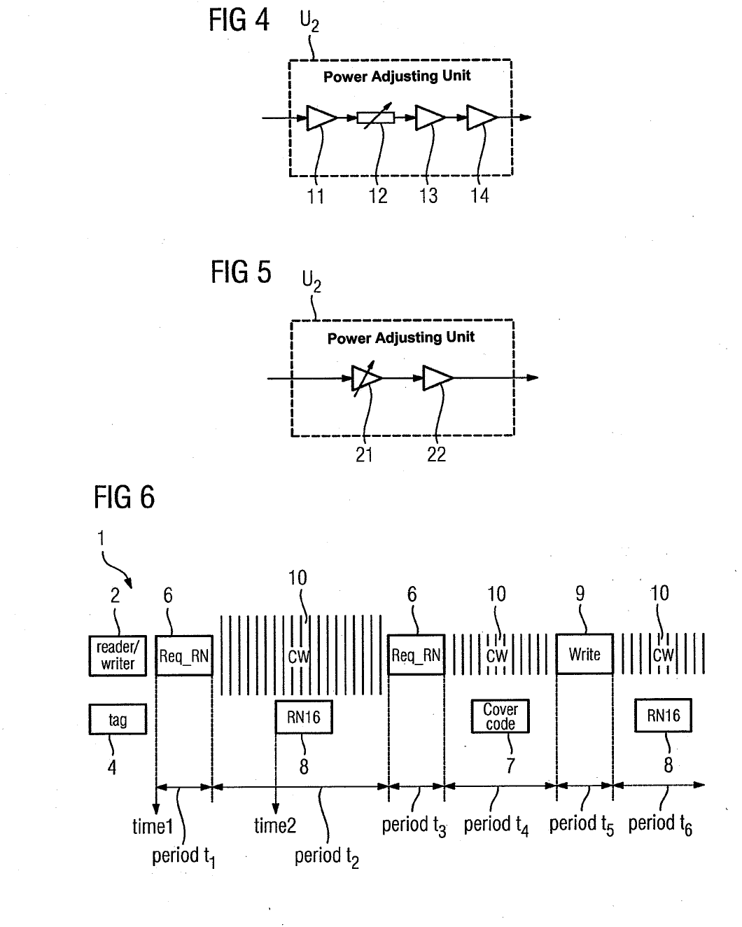

Two specific examples for realizing the power adjusting unit U₂ are shown in FIGS. 4 and 5.

The method for realizing the power adjusting unit U₂ of FIG. 4 is based on a variable attenuator. The modulated transmitting signals generated by the transmitting signal generating unit U₁ enter the power adjusting unit U₂. Here, after the transmitting signals have been amplified by a pre-amplifier 11, they are sent to a variable attenuator 12, and after having been attenuated by a variable attenuation value by the variable attenuator 12, they are sent into a power preamplifier 13 and a main power amplifier 14 to be amplified. Here, the gain given to the transmitting signals by each amplifier is fixed. The final gain adjustment for the transmitting signals by the power adjusting unit U₂ depends on the adjustment of the attenuation value of the variable attenuator. After this gain path, the continuous waves 10 of the enhanced period have their gain set by the gain controlling unit U₅ from the power adjusting unit U₂, and the transmitting power thereof can reach the enhanced transmitting power, where the transmitting signals are sent out by the antenna unit U₃.

In the simplest case, the variable attenuator 12 has a high attenuation value corresponding to the low gain set by the gain controlling unit U₅, and has a low attenuation value corresponding to the high gain set by the gain controlling unit U₅. When the gain controlling unit U₅ sets a low gain to the power adjusting unit U₂, the variable attenuator 12 adopts the high attenuation value to attenuate the transmitting signal with a greater attenuation. When the gain controlling unit U₅ sets a high gain, the variable attenuator 12 adopts the low attenuation value to attenuate the transmitting signal with a smaller attenuation.

The method for realizing the power adjusting unit in FIG. 5 is based on a variable power amplifier. Here, modulated transmitting signals generated by the transmitting signal generating unit U₁ enter the power adjusting unit U₂, where, the transmitting signals are amplified by a variable power amplifier 21 and a fixed power amplifier 22. Here, the gain given to the transmitting signals by the fixed amplifier 22 is fixed, and the final gain adjustment given to the transmitting signals by the power adjusting unit U₂ depends on the adjustment of the attenuation value of the variable attenuator 12. After this gain path, the continuous waves 10 of the enhanced period have the gain set for them by the gain controlling unit U₅ from the power adjusting unit U₂, and the transmitting power thereof can reach the enhanced transmitting power, by then the transmitting signals are sent out by the antenna unit U₃.

In the simplest case, the variable power amplifier 21 has a high gain value corresponding to the high gain set by the gain controlling unit U₅, and has a low gain value corresponding to the low gain set by the gain controlling unit U₅. When the gain controlling unit U5 sets a high gain to the power adjusting unit U₂, the variable power amplifier 21 adopts the high attenuation value to set the transmitting signal with a greater gain; when the gain controlling unit U₅ sets a low gain, the variable power amplifier 21 adopts the low gain value to set the transmitting signal with a smaller gain.

In an alternative embodiment of the present invention, the energy supply to the tags 4 is increased by extending the time for the reader/writer 2 to transmit the continuous waves 10. FIG. 6 is a process illustrating the alternative embodiment in accordance with the invention. Here, however, the process shown in FIG. 6 is basically the same as the process shown in FIG. 2, and redundant aspects will not be described further. The differences between the process of FIG. 2 and FIG. 6 is in the transmitting power and the transmitting time length for the continuous waves 10 during the period t₂.

As mentioned above, the reader/writer 2 will send the command signals and the continuous waves 10 during the communication process, and the tags 4 can obtain energy from the signals sent by said reader/writer 2. In this embodiment, the time length for the reader/writer 2 to transmit the continuous waves 10 to the tags 4 is extended, i.e., the energy obtained by the passive tags 4 can be increased correspondingly, thereby increasing the rewritable range I. Specifically, the reader/writer 2 selects at least one period, such as the period t₂, from those periods (i.e., the period t₂, t₄, t₆) for transmitting the continuous waves 10 as the enhanced period, and the time length for transmitting the signals to the tags 4 is adjusted, so as to send the continuous waves 10 with the extended time length to the tags 4 during the enhanced period, and to send the signals with the time length determined by the conventional method to the tags 4 during the other periods.

On the other hand, extending the time length for the reader/writer 2 to transmit the continuous waves 10 to the tags 4, will increase the time used on the writing operation by the radio-frequency identification system 1, thereby reducing the efficiency of the writing operation. In order to achieve a better balance between the rewritable range I and the efficiency of the writing operation, the reader/writer 2 can be triggered to select at least one period as the enhanced period when the preset condition is met, and sends the continuous waves 10 with the extended time length during the period. Consequently, the time length for the continuous waves 10 will be extended only when necessary, and therefore the time spent on the writing operation can be reduced as much as possible. Here, the preset condition comprises the received signal strength from said reader/writer 2 to the tags 4 is less than a preset reference value for the received signal strength, or the bit number to be written into the tags 4 by said reader/writer 2 is greater than a preset reference value for the bit number. In accordance with the disclosed embodiments, the reader/writer 2 detects the received signal strength indicator (RSSI) of the tag 4 to which a writing operation is currently performed, and the received signal strength is then compared with a preset reference value for the received signal strength, if said received signal strength is less than the preset reference value for the received signal strength, the preset condition is then established as being met. Alternatively, the reader/writer 2 detects the number of bits to be sent to the tag 4 to which a writing operation is performed currently, and the bit number is compared with a preset reference value for the bit number. Here, if the bit number is greater than the preset reference value for the bit number, then the preset condition is established as being met. Preferably, the first period for transmitting the continuous waves 10 after having determined that the preset condition is met is used as an enhanced period, and this can promptly increase the energy supply to the tags 4 with insufficient energy, thereby improving the reliability of the subsequent operation even more.

In accordance with the presently contemplated embodiment, as an example, only one period t₂ is selected to enhance the transmitting power of the continuous waves 10. Alternatively, more than one period, such as the periods t₂, t₄, can also be selected to enhance the transmitting power of the continuous waves 10. It is better to select the number of the enhanced periods according to the specific needs for energy by the tag's writing operation, so as to achieve better effects.

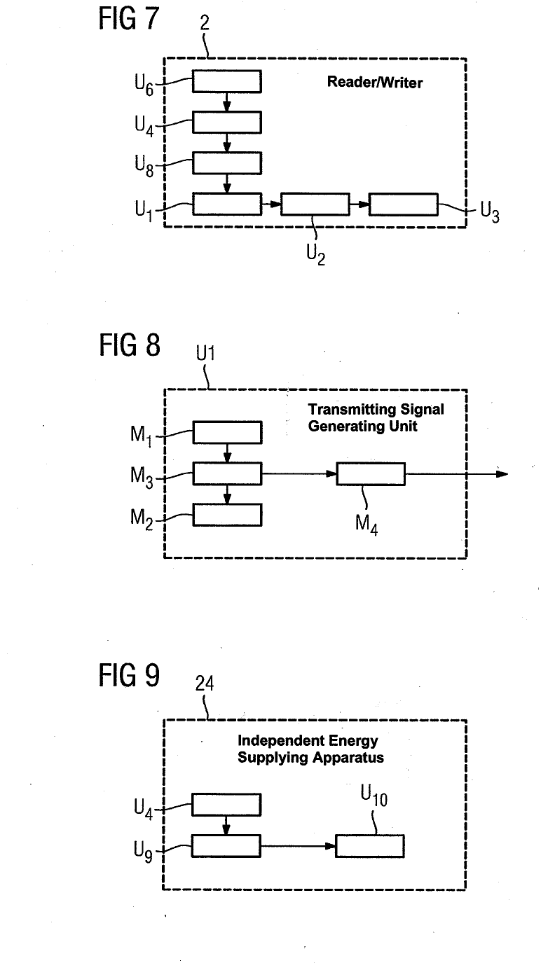

FIG. 7 is an illustration of a reader/writer 2 for implementing the method in accordance the alternative embodiment of the present invention.

In accordance with the contemplated embodiment, the reader/writer 2 comprises a transmitting signal generating unit U₁, a power adjusting unit U₂, an antenna unit U₃, a period selecting unit U₄ and a time length setting unit U₈. Here, the transmitting signal generating unit U₁ generates transmitting signals to be sent to the tags 4, and the transmitting signals comprise at least one period for transmitting the command signals and at least one period for transmitting the continuous waves 10, and the transmitting signals are then output to the power adjusting unit U₂. The power adjusting unit U₂ is used for performing a power adjustment to the transmitting signals provided by the transmitting signal generating unit U₁ according to the set gain. The antenna unit U₃ is used for transmitting the transmitting signals from the power adjusting unit U₂. The power adjusting U₂ unit and the antenna unit U₃ basically correspond to units of the existing reader/writer 2, and for their detailed realization reference is to be made to the prior art.

In accordance with the reader/writer 2 of the disclosed embodiments of the present invention, a period selecting unit U₄ is also provided in the reader/writer 2, which is used for selecting at least one period from the periods for transmitting continuous waves 10 as an enhanced period.

In the reader/writer 2 of the present disclosed embodiment of the invention, a time length setting unit U₈ is also provided, which is used for controlling the time length of the transmitting signals of the transmitting signal generating unit U₁, so as to extend the time length of the above-mentioned period for transmitting the continuous waves 10 during said enhanced period.

In order to achieve a better balance between the rewritable range I and the efficiency of the writing operation, the reader/writer 2 is triggered to select at least one period as the enhanced period when the preset condition is met and the continuous waves 10 are sent out over the extended time length during the period. To achieve this, the reader/writer 2 of the contemplated embodiment further comprises a condition judging unit U₆ for detecting the received signal strength for the tag 4, where when the received signal strength is less adjusted to be than a preset reference value for the received signal strength, the period selecting unit U₄ is triggered to select at least one period from the periods for transmitting the continuous waves 10 as an enhanced period. Alternatively, a condition judging unit U₆ is provided for detecting a bit number to be written to the tag 4, where when the condition judging unit U6 judges that the bit number is greater than a preset reference value for the bit number, it triggers the period selecting unit U₄ to select at least one period from the periods for transmitting the continuous waves 10 as an enhanced period.

As shown in FIG. 8, the transmitting signal generating unit U₁ can specifically comprise a continuous wave sequence providing module M₁, a command sequence providing module M₂, a sequence synthesizing module M₃ and a modulating module M₄. Here, the continuous wave sequence providing module M₁ is used for providing a continuous wave sequence to be sent to the tags 4, and for determining the time length of the continuous wave sequence according to the configuration of the time length setting unit U₈, so as to make it reach the time length set by the time length setting unit U₈. Here, the so-called continuous wave sequence is the digital sequence for generating the continuous waves 10. The command sequence providing module M₂ is used for providing a command sequence to be sent to the tags 4. Here, the so-called command sequence is the digital sequence for generating the command signals. The sequence synthesizing module M₃ is used for synthesizing the command sequence and the continuous wave sequence into a digital sequence to be sent to the tags 4. The modulating module M₄ is used for modulating the digital sequence output from the sequence synthesizing module, generating the transmitting signals, and then for output to the power adjusting unit U₂.

In another embodiment of the present invention the energy supply to the tags 4 is increased by adding an independent energy supplying apparatus 24 in the radio-frequency identification system 1 using the passive tags 4. The main idea thereof is to dispose at least one independent energy supplying apparatus 24 in the radio-frequency identification system 1 using the passive tags 4, which sends a segment of continuous wave 10 with a certain length during the communication process of the radio-frequency identification system 1, so as to provide additional energy to the tags 4. The continuous waves 10 sent by the independent energy supplying apparatus 24 should be in line with a maximum allowable transmitting power limited by the radio-related regulations.

As mentioned above, the reader/writer 2 will send the command signals and the continuous waves 10 during the communication process, and the tags 4 can obtain energy from the signals, i.e., the continuous waves 10, sent by the reader/writer 2. In order to avoid the interference to the communication of the radio-frequency identification system 1, it is preferable for the independent power supplying apparatus 24 to select the periods of the reader/writer 2 to transmit the continuous waves 10 to the tags 4, such as the period t₂, t₄, t₆ shown in FIG. 2, to send a segment of continuous wave 10 with a certain length to the tags 4, and the selected period can be one (e.g., the period t₂ shown in FIG. 2), or also more than one (e.g., the period t₂, t₄ as shown in FIG. 2), where the time length of this segment of the continuous wave 10 is the same as the time length of the period for the reader/writer 2 to transmit the continuous waves 10 to the tags 4. Specific realization can be as follows, the independent energy supplying apparatus 24 selects at least one period from those periods for transmitting the continuous waves 10 as an enhanced period, monitors the communication process of said reader/writer 2, and when it is determined that it enters said enhanced period, it sends the continuous waves 10 to the tags 4 until it monitors that said reader/writer 2 starts to send a next command. Specifically, it is by monitoring that the reader/writer 2 has finished sending a command that the entering point of the enhanced period is determined. The independent energy supplying apparatus can monitor the communication process of the reader/writer 2 in a way similar to that for the tags 4 to receive the signals sent by the reader/writer 2, but it does not need to return any information to the reader/writer 2.

The independent energy supplying apparatus 24 can be an independent entity, and therefore it can be disposed near the tags 4 which are far away from the reader/writer 2, and thus this can effectively improve the reliability of the writing operation of these tags 4. Preferably, more than one independent energy supplying apparatus 24 can be disposed in the radio-frequency identification system 1, and these independent energy supplying apparatuses 24 can be correspondingly distributed according to a desired rewritable range I, thereby forming a distributed independent energy supplying apparatus network. This can extend the rewritable range I in a more targeted manner.

FIG. 9 is an illustration of a block schematic diagram of the independent energy supplying apparatus 24 in accordance with an alternative embodiment. The independent energy supplying apparatus 24 comprises a period selecting unit U₄, a period controlling unit U₉, and a continuous wave transmitting unit U₁₀. Here, the period selecting unit U₄ is used for selecting at least one period from the periods for transmitting the continuous waves 10 as the enhanced period. The period controlling unit U₉ is used for monitoring the communication process of the reader/writer 2, when the starting of the enhanced period by the reader/writer 2 is determined, it transmits an instruction to send the continuous waves 10. When the beginning of transmission of a next command by the reader/writer 2 is determined, it transmits an instruction to stop transmitting the continuous waves 10. The continuous wave transmitting unit U₁₀ is used for transmitting the continuous waves 10 to the tags 4 when it receives an instruction for transmitting the continuous waves 10 sent by the period controlling unit U₉, until it receives the instruction to stop transmitting the continuous waves 10.

In each of the above described embodiments, the process in the stage of the writing operation is mainly exemplary embodiments for the present invention. Those skilled in the art can understand that if the enhanced period in the above embodiment is selected during the reading operation, then it can be an embodiment in the reading operation. When the present invention is applied to the reading operation, the specific method thereof is similar to the above embodiments, but in the case of the reader/writer 2 not executing the writing operation, it is not by the number of written bits to determine whether to trigger to enhance the power or extend the transmitting time. Therefore, for the embodiment applied to the reading operation, no further redundant description is to be made here.

Therefore, in the present disclosed embodiment invention, by enhancing the transmitting power of certain or some transmitting periods or extending the transmitting time thereof during the reading and/or writing operations, the energy supply to the tags 4 can be increased, thereby improving the reliability of the subsequent operations.

It can be seen from the above description that, in the implementation of the contemplated embodiments of the present invention, it is only necessary to make partial modification to the existing reader/writers 2, without any modifications to the tags 4, this being simple to implement. In one embodiment, it is only necessary to add a new apparatus in the system 1, without any modification to the entire radio-frequency identification system, and therefore it is convenient for use with a variety of radio-frequency identification systems.

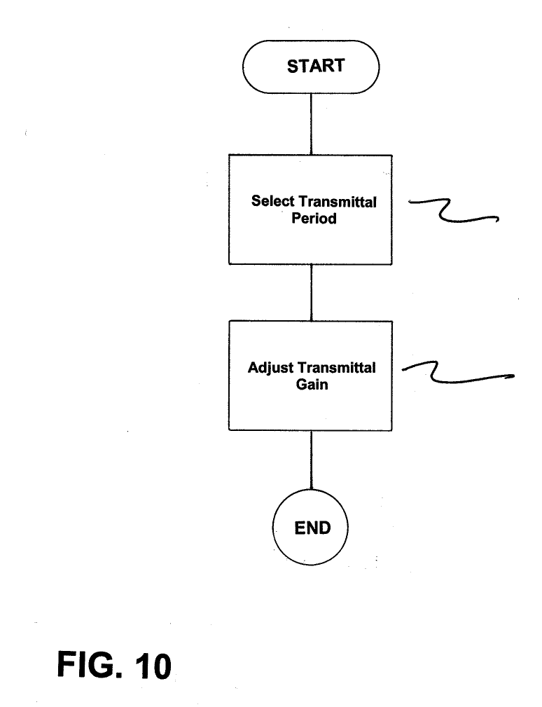

FIG. 10 is an illustration of a method for providing energy to a passive tag in a radio-frequency identification system in which a communication process of a reader/writer of said radiofrequency identification system comprises at least one period for transmitting command signals and at least one period for transmitting continuous waves, and the passive tag in the radio-frequency identification system obtains energy from said continuous waves. The method comprises selecting, by the reader/writer, at least one period from the at least one period for transmitting the continuous waves as an enhanced period, as indicated in step 1010. At least one of a gain for transmitting signals to send the continuous waves with an enhanced transmission power during said enhanced period and a time length for transmitting the continuous waves to the tag to send the continuous waves with an extended time length during said enhanced period are then adjusted by the reader/writer, as indicated in step 1020.

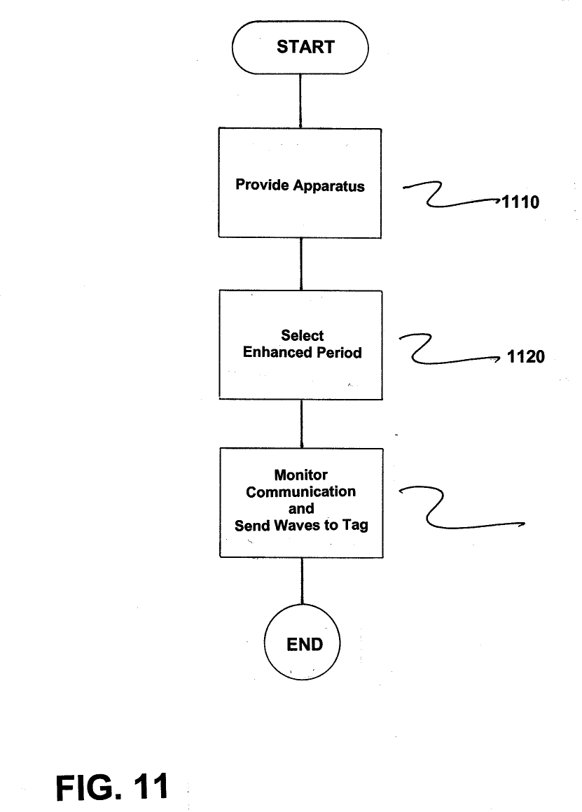

FIG. 11 is an illustration of an alternative method for providing energy to a passive tag in a radio-frequency identification system in which a single communication process of a reader/writer of the radiofrequency identification system comprises at least one period for transmitting command signals and at least one period for transmitting continuous waves, and the passive tag of the radio-frequency identification system obtains energy from the continuous wave signals. The method comprises providing the radio-frequency identification system with at least one independent energy supplying apparatus, as indicated in step 1110. At least one period as an enhanced period from the at least one period for transmitting the continuous waves is selected by the at least one independent energy supplying apparatus, as indicated in step 1120. Next, the single communication process of the reader/writer is monitored by the at least one independent energy supplying apparatus and, when the at least one independent energy supplying apparatus determines that said enhanced period is entered, the continuous waves is sent to the passive tag until the reader/writer starts to send a next command, as indicated in step 1130.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

1-15. (canceled)

16. A method for providing energy to a passive tag in a radio-frequency identification system, a communication process of a reader/writer of said radiofrequency identification system comprises at least one period for transmitting command signals and at least one period for transmitting continuous waves, and the passive tag in said radio-frequency identification system obtains energy from said continuous waves, the method comprising:
selecting, by the reader/writer, at least one period from the at least one period for transmitting the continuous waves as an enhanced period; and
adjusting, by the reader/writer, at least one of a gain for transmitting signals to send the continuous waves with an enhanced transmission power during said enhanced period and a time length for transmitting the continuous waves to the tag to send the continuous waves with an extended time length during said enhanced period.

17. The method as claimed in claim 16, wherein said selecting step comprises:
selecting, by the reader/writer, at least one of a current or a subsequent period for transmitting the continuous waves as said enhanced period when the reader/writer detects that a received signal strength for the tag is less than a preset reference value for the received signal strength.

18. The method as claimed in claim 16, wherein said selecting step comprises:
selecting, by the reader/writer, at least one of a current and a subsequent period for transmitting the continuous waves as said enhanced period when a bit number to be written by the reader/writer into the tag is greater than a preset reference value for the bit number.

19. The method as claimed in claim 16, wherein the enhanced period is pre-selected by the reader/writer in said selecting step.

20. The method as claimed in claim 16, wherein the enhanced transmission power is greater than a transmission power for transmitting command signals.

21. The method as claimed in claim 16, wherein the enhanced transmission power is a maximum allowable transmission power.

22. The method as claimed in claim 16, further comprising:
performing, by the reader/writer, a training period to obtain relevant information for adjusting the gain.

23. A reader/writer, comprising:
a transmitting signal generating unit configured to generate transmission signals to be sent to a tag, said transmission signals comprising at least one period for transmitting command signals and at least one period for transmitting continuous waves;
a power adjusting unit configured to receiving the transmitted signals provided by the transmission signal generating unit and configured to perform a power adjustment to the transmitted signals in accordance with a set gain;
an antenna unit configured to transmits out the transmitted signals from the power adjusting unit;
a period selecting unit configured to select at least one period from said at least one period for transmitting continuous waves as an enhanced period; and
at least one of a gain controlling unit configured to adjust the gain of said power adjusting unit to set the continuous waves to an enhanced transmitting power during the enhanced period and a time length setting unit configured to control a time length of the transmitted signals of said transmitting signal generating unit to extend the time length of the at least one period for transmitting the continuous waves during the enhanced period.

24. The reader/writer as claimed in claim 23, said reader/writer further comprising:
a condition judging unit configured to detect a received signal strength for the tag;
wherein the condition judging unit triggers the period selecting unit to select the enhanced period upon determining that the received signal strength is less than a preset reference value for the received signal strength.

25. The reader/writer as claimed in claim 23, wherein said reader/writer further comprises:
a condition judging unit configured to detect a bit number to be written to the tag;
wherein the condition judging unit triggers the period selecting unit to select the enhanced period upon determining that the bit number is greater than a preset reference value for the bit number.

26. The reader/writer as claimed in claim 23, wherein said reader/writer further comprises:
a training unit configured to execute a training period and obtain relevant information to determine the gain to set for the power adjusting unit during the enhanced period and to provide the set gain to the gain controlling unit.

27. The reader/writer as claimed in claim 24, wherein said reader/writer further comprises:
a training unit configured to execute a training period and obtain relevant information to determine the gain to set for the power adjusting unit during the enhanced period and to provide the set gain to the gain controlling unit.

28. The reader/writer as claimed in claim 25, wherein said reader/writer further comprises:
a training unit configured to execute a training period and obtain relevant information to determine the gain to set for the power adjusting unit during the enhanced period and to provide the set gain to the gain controlling unit.

29. A method for providing energy to a passive tag in a radio-frequency identification system, a communication process of a reader/writer of said radiofrequency identification system comprising at least one period for transmitting command signals and at least one period for transmitting continuous waves, and the passive tag of said radio-frequency identification system obtaining energy from said continuous wave signals, the method comprising:
providing the radio-frequency identification system with at least one independent energy supplying apparatus;
selecting, by the at least one independent energy supplying apparatus, at least one period as an enhanced period from the at least one period for transmitting the continuous waves; and
monitoring, by the at least one independent energy supplying apparatus, the communication process of said reader/writer and, when the at least one independent energy supplying apparatus determines that said enhanced period is entered, sending the continuous waves to the passive tag until said reader/writer starts to send a next command.

30. The method as claimed in claim 29, wherein the at least one independent energy supplying apparatus is provided near the passive tag which is relatively far away from the reader/writer.

31. The method as claimed in claim 29, wherein the at least one independent energy supplying apparatus is correspondingly provided in accordance with a desired coverage range.

32. An independent energy supplying apparatus, comprising:
a period selecting unit configured to select at least one period from periods in which a reader/writer of a radio-frequency identification system sends continuous waves as an enhanced period;
a period controlling unit configured to monitor a communication process of said reader/writer, transmit out an instruction to transmit the continuous waves upon determining that the said reader/writer starts the enhanced period, and configured to transmit out an instruction to stop transmitting the continuous waves upon determining that the reader/writer starts to send a next command; and
a continuous wave transmitting unit configured to transmit continuous waves to the passive tag upon receiving the instruction to transmit the continuous waves sent by the period controlling unit until receiving the instruction to stop transmit the continuous waves.
